(19) United States
(12) Patent Application Publication
(10) Pub. No.: US 2003/0007567 A1
(43) Pub. Date: Jan. 9, 2003

(54) Method and apparatus for real-time editing of plural content streams

(76) Inventors: David A. Newman, San Diego, CA (US); Jeffrey V. Schafer, Carlsbad, CA (US); Robert C. Hsieh, Taiwan (CN); Jon D. Garrett, Solana Beach, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/183,090

(22) Filed: Jun. 26, 2002

Related U.S. Application Data
(60) Provisional application No. 60/301,016, filed on Jun. 26, 2001.

(51) Int. Cl. H04N 7/12; H04N 11/02

(52) U.S. Cl. 375/240.25; 375/240.27

(57) ABSTRACT

A system and method disposed to enable real-time creation and manipulation of digital media within a conventional personal computer environment without dedicated hardware assistance is disclosed herein. In particular, one disclosed method is directed to generating a compressed video output signal using a computing device. The method includes decoding a previously compressed first digital video bit stream to obtain a first decoded digital video signal. The first decoded digital video signal is mixed with a second digital video signal in order to produce a mixed video signal. In addition, the mixed video signal is recompressed so as to form the compressed video output signal wherein the mixing and recompressing are performed by the computing device in substantially in real-time.

### CROSS-REFERENCE TO RELATED APLICATIONS

This application is related and claims priority to U.S. Provisional Patent Application Serial No. 60/301,016, which is hereby incorporated by reference in its entirety.

### FIELD OF THE INVENTION

The present invention relates to the manipulation and editing of plural multimedia information sources. More particularly, the present invention relates to the real-time mixing and editing of plural multimedia information sources using an efficient codec configured to produce a compressed mixed output signal capable of being directly communicated over a band-limited communication channel.

### BACKGROUND OF THE INVENTION

As is well known, digital formats are now widely used to develop and edit media content. For example, more sophisticated editing of video can be accomplished if the video source material is converted to a digital format prior to performing the desired editing operations. To the extent necessary, the edited digital images may then be converted back to the format of the original source material.

Although facilitating editing operations, digital content that has not been compressed generally necessitates use of significant amounts of memory and transmission bandwidth. For example, a single uncompressed digital image of only commonplace resolution may require multiple megabytes of memory. Since substantially greater resolution is often required, it is apparent that uncompressed video sequences containing many individual images may consume enormous amounts memory and transmission bandwidth resources.

Accordingly, standards for image compression have been developed in an effort to reduce these resource demands. One set of standards generally applicable to the compression of video has been developed and published by the Moving Picture Experts Group (“MPEG”). The MPEG standards contemplate that images may be compressed into several different types of frames by exploiting various image redundancies (e.g., spatial and/or temporal redundancies. Similarly, Digital Video (“DV”) is a standardized video compression format that has been more recently developed. DV produces a fixed data rate of approximately 25 Mbps utilizing a fixed compression ratio and, like MPEG, relies on discrete cosine transforms.

Prior to editing or otherwise manipulating MPEG and other compressed image information, each frame of interest is typically decoded in its entirety. That is, the combination or “mixing” of MPEG and other compressed video frames generally requires such complete decoding of “blocks” of frames in order to remove the interdependence between frames inherent in the compressed image content. In this regard images in an MPEG sequence are generally formed into a group of pictures (“GOP”), which upon decoding results in a sequence of individual uncompressed frames. Once completely decoded, individual frames from the same or different sources are represented independently of other frames and can be reordered or combined in non real-time. If the resultant composite image or sequence of images is desired to be compressed, the image or sequence is then recompressed using the MPEG standard.

Unfortunately, manipulation of compressed media content which is then re-encoded using accepted standards (e.g., MPEG and DV) tends to demand processing performance that is generally beyond the capabilities of conventional personal computers. This disadvantageous situation has arisen at least in part because accepted digital media standards have generally been geared toward aims other than facilitating editing or manipulation of digital content. For example, MPEG was developed primarily to serve as a distribution format for DVD and digital media broadcast. Digital video (DV) is believed to have been formulated as a mechanism for capture of tape-based information from personal video equipment such as camcorders and the like.

Although standards such as MPEG and DV have furthered their intended purposes, the internal format of each has rendered codecs compatible with such standards relatively ineffective in efficiently creating or manipulating digital media. That is, when used for the purpose of creating or manipulating digital media, such encoders tend to require a sufficiently large amount of computing resources to preclude real-time creation or manipulation of digital media content using conventional personal computer hardware. Real-time performance is attained when all video manipulation, mixing and encoding is effected in such a way that the resulting output is produced at the full video frame rate (i.e., frames are not lost or dropped).

For example, FIG. 1 depicts a known arrangement 10 for editing compressed digital video previously stored on disk memory 12. As shown, one or more compressed video streams 16 from the disk 12 are provided to a processing unit 20 (e.g., a conventional personal computer) configured to manipulate the information within the video streams 16. Specifically, the processing unit 20 decompresses the video streams 16 and then effects various desired editing functions (e.g., mixing of special effects, titles and transitions). However, existing encoding approaches executing on processing units 20 of the type incorporated within conventional personal computers are not sufficiently fast to allow the mixed, uncompressed video to be recompressed in real-time for transmission across a band-limited channel 22. That is, the processing unit 20 stores the mixed video to the disk 12 after it has been compressed as necessary for transmission. In a separate processing step, the mixed, compressed video is then retrieved from the disk memory 12 and buffered 24 by the processing unit 20. The buffered video is then output for transmission over a band-limited channel. It is observed that the use of conventional compression techniques precludes this transmission from being performed in real-time; that is, such techniques require that the mixed video be compressed and stored to disk 12 prior to being separately buffered and processed for transmission across channel 22.

When it has been desired to create and edit digital media content in real-time, one approach has entailed complementing existing personal computer platforms with dedicated compression hardware. FIG. 2 illustrates an exemplary arrangement in which such dedicated hardware comprises a video encoding device in the form of PCI card 40 in communication with the computer's processing unit via a PCI bus 42. In particular, mixed and uncompressed video produced by the processing unit is compressed by a dedicated encoding device and output for transmission over a channel. Unfortunately, such dedicated encoding devices tend to be expensive and may be inconvenient to install.

### SUMMARY OF THE INVENTION

The present invention relates to a system and method disposed to enable real-time creation and manipulation of digital media within a conventional personal computer environment without dedicated hardware assistance. In particular, the present invention is directed in one aspect to a method for generating a compressed video output signal using a computing device. The method includes decoding a previously compressed first digital video bit stream to obtain a first decoded digital video signal. The first decoded digital video signal is mixed with a second digital video signal in order to produce a mixed video signal. In addition, the mixed video signal is recompressed so as to form the compressed video output signal wherein the mixing and recompressing are performed by the computing device in substantially in real-time.

### BRIEF DESCRIPTION OF THE DRAWINGS

For a better understanding of the nature of the features of the invention, reference should be made to the following detailed description taken in conjunction with the accompanying drawings, in which:

FIG. 1 depicts a known arrangement for editing compressed digital video.

FIG. 2 depicts a known arrangement for editing compressed digital video which utilizes dedicated compression hardware in the context of a conventional personal computer platform.

FIG. 3 is a block diagram illustrative of an encoding system configured to mix and edit digital media content in accordance with the invention.

FIG. 4 is a block diagram illustrating the principal components of a processing unit of the inventive encoding system.

FIG. 5 illustratively represents the filtering of a video frame using sub-band coding techniques in order to produce high frequency sub-band information and low frequency sub-band information.

FIG. 6 depicts the manner in which a pair of sub-band image information sets derived from a source image can be vertically filtered in the same way to produce four additional sub-band image information sets.

FIG. 7 illustratively depicts a way in which increased compression may be achieved by further sub-band processing a low-pass sub-band image information set.

FIGS. 8A and 8B illustrate one manner in which the symmetric CODEC of the present invention may be configured to exploit redundancy in successive image frames.

FIG. 9 is a flow chart representative of a video editing process performed with respect to each video frame included within a compressed stream.

FIGS. 10A and 10B illustratively represent exemplary data formats for video sequences edited in accordance with the present invention.

FIG. 11 is a block diagram of a computer system configured in accordance with an exemplary embodiment of the invention to decode video signals encoded in accordance with the present invention.

### DETAILED DESCRIPTION OF EMBODIMENTS OF THE PRESENT INVENTION

System Overview

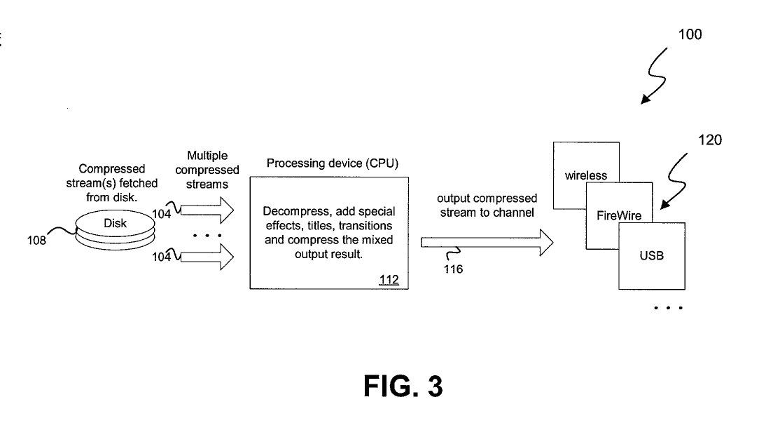

FIG. 3 is a block diagram illustrative of an encoding system 100 configured to mix and edit digital media content in accordance with the invention. In the embodiment of FIG. 3, multiple compressed digital content streams 104 (e.g., sequences of frames of digital images or audio) are stored on disk memory 108. As shown, one or more of the compressed digital content streams 104 are provided to a processing unit 112 (e.g., a personal computer incorporating a Pentium-class CPU) configured to manipulate the information within the content streams 104 in accordance with the present invention. As is described below, the processing unit 112 decompresses the content streams 104 and, as desired, mixes them or otherwise effects various desired editing functions (e.g., introduction of special effects, titles and transitions). Advantageously, the present invention enables the mixed, uncompressed video to be recompressed by the processing unit 112 in real-time for transmission across a band-limited channel. As is described below, the processing unit 112 executes an efficient, wavelet-based compression process which permits the resultant mixed, compressed video 116 to be directly transmitted over a band-limited channel 120 (e.g., a Universal Serial Bus (USB), wireless communication link, EtherNet, or Institute of Electrical and Electronics Engineers (IEEE) Standard No. 1394 (“Firewire”) connection) without intermediate storage to the disk memory 108 or subsequent buffering by the processing unit 112. Moreover, contrary to conventional real-time editing approaches, the system 100 of the present invention may be executed using a conventional personal computer lacking a dedicated compression device.

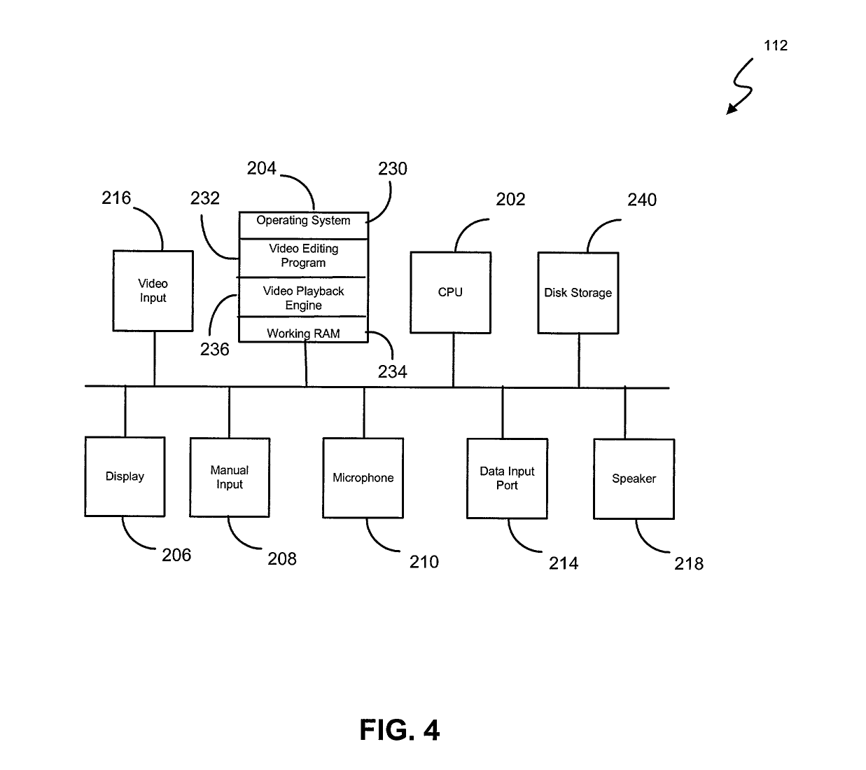

FIG. 4 is a block diagram illustrating the principal components of the processing unit 112 as configured in accordance with an exemplary implementation of the present invention. In the exemplary implementation of FIG. 4, the processing unit 112 comprises a standard personal computer disposed to execute video editing software created in accordance with the principles of the present invention. Although the processing unit 112 is depicted in a “standalone” arrangement in FIG. 4, in alternate implementations the processing unit 112 may function as a video editor incorporated into a video recorder or video camera.

As shown in FIG. 4, the processing unit 112 includes a central processing unit (“CPU”) 202 adapted to execute a multi-tasking operating system 230 stored within system memory 204. The CPU 202 may comprise any of a variety of microprocessor or microcontrollers known to those skilled in the art, such as a Pentium-class microprocessor. As is described further below, the memory 204 stores copies of a video editing program 232 and a video playback engine 236 executed by the CPU 202, and also includes working RAM 234. The processing unit 112 further includes disk storage 240 containing plural video compressed video streams capable of being mixed and otherwise manipulated into a composite, compressed video during execution of the video editing program 232. The video streams may be initially stored on disk storage 240 in any known compression format (e.g., MPEG or JPEG). Disk storage 240 may be a conventional read/write memory such as a magnetic disk drive, floppy disk drive, compact-disk read-only-memory (CD-ROM) drive, digital video disk (DVD) read or write drive, transistor-based memory or other computer-readable memory device as is known in the art for storing and retrieving data. Disk storage 240 may alternately be remotely located from CPU 202 and connected thereto via a network (not shown) such as a local area network (LAN), a wide area network (WAN), or the Internet.

CPU 202 communicates with a plurality of peripheral equipment, including video input 216. Video input may be a camera or other video image capture device. Additional peripheral equipment may include a display 206, manual input device 208, microphone 210, and data input port 214. Display 206 may be a visual display such as a cathode ray tube (CRT) monitor, a liquid crystal display (LCD) screen, touch-sensitive screen, or other monitors as are known in the art for visually displaying images and text to a user. Manual input device 208 may be a conventional keyboard, keypad, mouse, trackball, or other input device as is known in the art for the manual input of data. Microphone 210 may be any suitable microphone as is known in the art for providing audio signals to CPU 202. In addition, a speaker 218 may be attached for reproducing audio signals from CPU 202. It is understood that microphone 210 and speaker 218 may include appropriate digital-to-analog and analog-to-digital conversion circuitry as appropriate.

Data input port 214 may be any data port as is known in the art for interfacing with an external accessory using a data protocol such as RS-232, USB, or Firewire. Video input 216 may be any interface as known in the art that receives video input such as a camera, microphone, or a port to receive video/audio information. In addition, video input 216 may consist of video camera attached to data input port 214.

Overview of Wavelet-Based Symmetric CODEC

In the exemplary embodiment the video editing program 230 implements a symmetric wavelet-based coder/decoder (“CODEC”) in connection with compression of a composite video signal generated on the basis of one or more video streams received from disk storage 240. The wavelet-based symmetric CODEC uses both spatial and temporal compression to achieve a data rate and image quality comparable to that produced using existing standards, yet achieves this performance using only a 2 frame (4 field) Group of Pictures (“GOP”) structure. This GOP length is small enough so that no further subdivision of the GOP is required for consumer and other video editing applications, greatly reducing system performance needs. In contrast to existing standardized approaches, the symmetric CODEC also facilitates “frame accurate” or sub-GOP video editing with relatively low processing overhead and at substantially lower data rates. In the exemplary embodiment the inventive CODEC is configured to be symmetric, meaning that substantially similar encoding and decoding transforms (i.e., transforms which are inverses of corresponding encoding transforms) are utilized and therefore substantially similar processing requirements are associated with execution of the encoding/decoding transforms. This results in the processing requirements associated with execution of the symmetric CODEC encoding transform being much less than those required by common encoding solutions utilizing motion estimation calculations (e.g., MPEG2). This may be attributed at least partially to the fact that such standardized CODECS have been designed for content distribution systems (e.g., for web streaming or for storage of lengthy films on DVD), in which encoding performance is substantially irrelevant (as decoding is performed far more frequently than encoding). Such standardized CODECs adapted for video distribution applications may generally be accurately characterized as “asymmetric”, in that substantially greater computing resources are required for the encoding operation relative to the decoding operation.

In contrast, in the exemplary embodiment the inventive CODEC is configured to be substantially symmetric in order to facilitate real-time editing and playback of plural sources of digital media content without the use of dedicated compression hardware. As discussed below, the computationally efficient and symmetric nature of the inventive symmetric CODEC enables a real-time editing and playback system to be created by placing a realization of the symmetric CODEC at either end of a band-limited channel. In this way multiple sources of digital media content may be mixed and compressed in real-time at the “encoding” side of the band-limited channel and played back in real time at the “decoding” side of the band-limited channel. As mentioned above, existing encoding techniques are not known to be capable of such real-time performance when executed using conventional personal computer hardware.

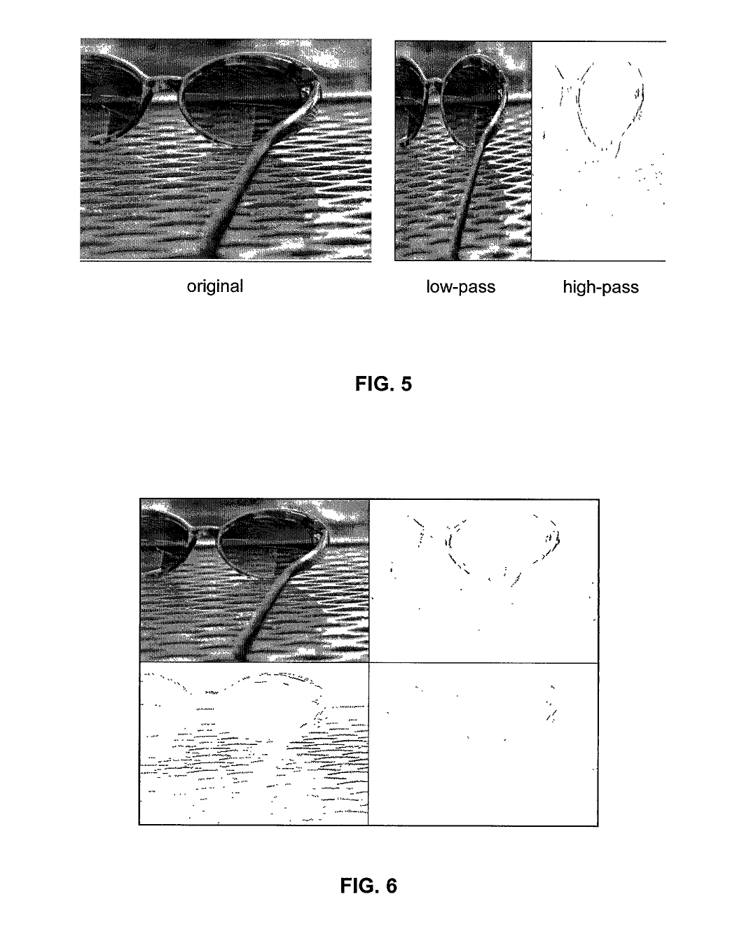

The inventive symmetric CODEC employs sub-band coding techniques in which the subject image is compressed though a series of horizontal and vertical filters. Each filter produces a high frequency (high-pass) component and a low frequency (low-pass) component. As shown in the exemplary illustrative representation of FIG. 5, a video frame of 720×480 pixels may be filtered using sub-band coding techniques to produce high frequency sub-band information of 360×480 pixels and low frequency sub-band information of the same size. The high frequency sub-band information is representative of edges and other discontinuities in the image while the low frequency sub-band is representative of an average of the pixels comprising the image. This filter can be as simple as the sum (low pass) and difference (high pass) of the 2-point HAAR transform characterized as follows:

For every pixel pair: Xᵢ and Xᵢ₊₁

one low-pass output: L_{j=X}ᵢ+Xᵢ₊₁

and one high-pass output: Hⱼ=Xᵢ−Xᵢ₊₁

In the exemplary embodiment all multiplication and division computations required by the transform are capable of being carried out using shift operations. The above transform may be reversed, or decoded, as follows:

Xᵢ=(Lⱼ+Hⱼ)÷2

and

Xᵢ₊₁=(Lⱼ−Hⱼ)÷2

As is known, the HAAR transform is one type of wavelet-based transform. The low-pass or “averaging” operation in the above 2-point HAAR removes the high frequencies inherent in the image data. Since details (e.g., sharp changes in the data) correspond to high frequencies, the averaging procedure tends to smooth the data. Similarly, the differencing operation in the above 2-point HAAR corresponds to high pass filtering. It removes low frequencies and responds to details of an image since details correspond to high frequencies. It also responds to noise in an image, since noise usually is located in the high frequencies.

Continuing with the above example, the two 360×480 sub-band image information sets derived from the 720×480 source image can then be HAAR filtered in the vertical dimension to produce the four additional 360×240 sub-band image information sets or depicted in FIG. 6. Each such sub-band image information set corresponds to the transform coefficients of a particular high-pass or low-pass sub-band. In order to effect compression of each high-pass sub-band, its transform coefficients are quantized, run-length encoded and entropy (i.e., statistical or variable-length) encoded. In this regard the blank areas in the high-pass sub-band image information sets are comprised largely of “zeros”, and are therefore very compressible. As shown in FIG. 7, increased compression may be achieved by further sub-band processing the low-pass sub-band image information set, which is typically done 3 to 4 times.

To improve the extent of compression beyond that possible using the “2,2” wavelet transforms illustrated above, longer filters such as those based upon “2,6” and the “5,3” wavelet transforms may also be employed. Both of the these wavelet transforms also exhibit the characteristics of HAAR wavelets in only requiring shifts and adds in order to perform the desired transform, and thus may be computed quickly and efficiently. The nomenclature arises as a result of the fact that a “2,6” wavelet transform is predicated upon 2 low-pass filter elements and 6 high-pass filter elements. Such a 2,6 wavelet transform capable of being implemented-within the symmetric CODEC may be characterized as follows:

For every pixel pair: Xᵢ₋₂ through Xᵢ₊₃

one low-pass output: Lⱼ=X_{i+X}ᵢ₊₁

and one high-pass output: Hⱼ=(−X_{i-2-X}ᵢ₋₁+8.Xⱼ−8.X_{i+1+X}ᵢ₊₂ +Xᵢ₊₃)/8

The above 2,6 transform may be reversed, or decoded, as follows:

Xᵢ=((Lⱼ₋₁+8.Lⱼ−Lⱼ₊₁)÷8)+Hⱼ)÷2

and

Xᵢ₊₁=((Lⱼ₋₁+8.Lⱼ−Lⱼ₊₁)÷8)−Hⱼ)÷2

Use of a longer wavelet results in the use of more of the pixels adjacent an image area of interest in computation of the sum and difference (low and high-pass) sub-bands of the transform. However, it is not anticipated that video and other digital content may be compressed to the extent necessary to result in data transmission rates significantly below those associated with conventional image formats (e.g., JPEG) solely through the use of relatively wavelets. Rather, in accordance with the present invention it has been found that significant reduction in such data transmission rates may be achieved by also exploiting temporal image redundancy. Although techniques such as the motion estimation processes contemplated by the MPEG standards have lead to substantial compression gains, such approaches require non-symmetric CODECS and significant processing resources. In contrast, the symmetric CODEC of the present invention implements a substantially more efficient method of providing increased compression gains and consequently is capable of being implemented in the environment of a conventional personal computer.

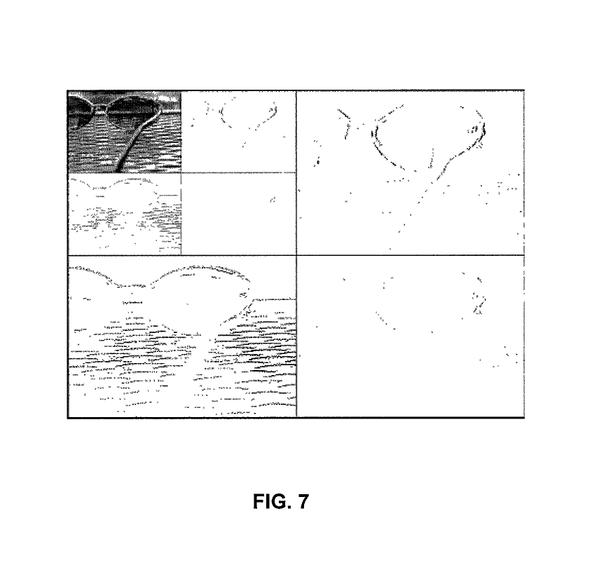

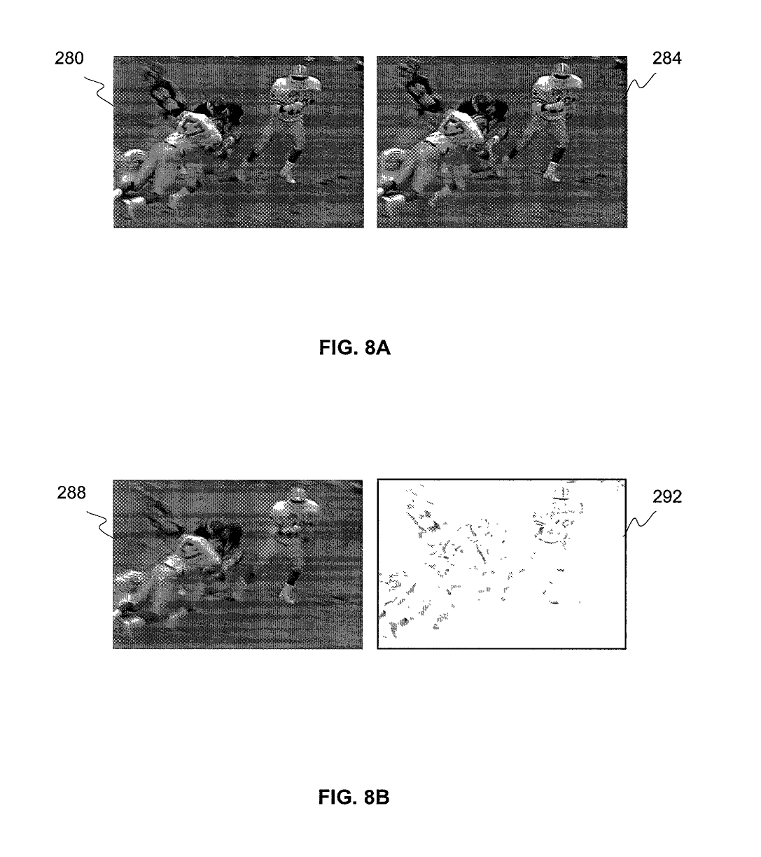

FIGS. 8A and 8B illustrate one manner in which the symmetric CODEC of the present invention may be configured to exploit redundancy in successive image frames. After performing the first 2D wavelet transform described above with reference to FIG. 6, the resulting low pass sub-band image information set of a given image frame 280 is, in accordance with a HAAR transform, summed and differenced with the low-pass sub-band image information set of the next frame 284. The low-pass sub-band image information set 288 resulting from the temporal sum operation carried out per the HAAR transform can then be further wavelet compressed in the manner described above with reference to FIGS. 6 and 7. In the case where a significant amount of motion is represented by successive image frames, the high-pass sub-band image information set 292 resulting form the temporal difference computed per the HAAR transform can also be wavelet-compressed to the extent additional compression is desired.

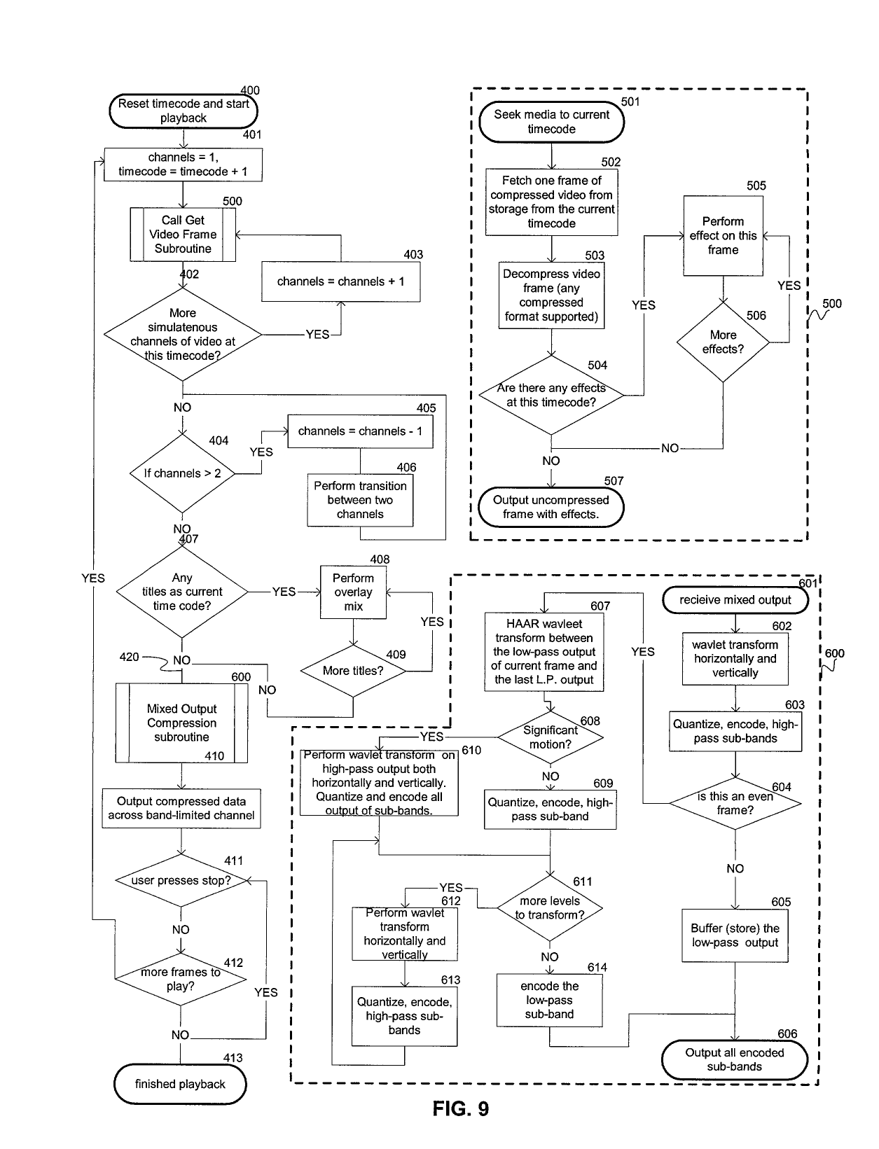

Operation of Video Editor Incorporating Wavelet-Based Symmetric CODEC FIG. 9 is a flow chart representative of a video editing process performed, under the control of the video editing program 232, with respect to each video frame included within a compressed stream 104. In the preferred embodiment the video editing program 132 is configured to separately operate on each color component of the applicable color space. That is, the symmetric CODEC performs the wavelet transforms described above on each color component of each video frame as if it were a separate plane of information. In the exemplary embodiment the symmetric CODEC operates with reference to the YUV color space in view of its efficient modeling of the human visual system, which allows for greater compression of the constituent color components once separated from the brightness components. In particular, the symmetric CODEC processes standard video as three separable planes: a brightness plane (i.e., “Luma” or “Y”, which is typically 720 pixels across for standard video) and two color planes (“Chroma”, or “U” and “V”, each of which is typically 360 pixels across for standard video.). The component planes of other color spaces are similarly separately processed by the symmetric CODEC.

Referring to FIG. 9, when it is desired to playback a video sequence previously stored on disk storage 240 in a standard compression format, a timecode is reset (step 400) to a start position. This start position is optionally set to any position desired by the user within a predetermined timeline associated with a video sequence. The number of video channels selected for playback is assumed to be at least one (step 401) In the common case of no video clip present at a particular timecode, the timecode is simply considered to contain one channel of black video. The frame of video at the current timecode is fetched (step 500) from disk storage 240 by seeking to the requested position within the media file (steps 501, 502). The retrieved frame is then decompressed via the known decompression routine associated with its format (e.g., JPEG or MPEG) (step 503). The resultant decompressed frame of data many contain any number of single channel effects (504), such as color correction, blurs, sharpens and distortions (505). Each special or other effect that is required to be rendered during user viewing on the selected video channel at the specified timecodes is applied in sequence (steps 505, 506). Once all the required effects have be added to the frame being processed, the frame is ready for down-stream mixing and is output to the next processing stage (step 507). The foregoing steps are performed upon the current frame of each channel of video stored within the disk storage 240 that is being concurrently decompressed (steps 402, 403) by the video playback engine 236.

If multiple channels of video stored on the disk storage 240 are selected for concurrent playback, transitions (or similar dual stream effect) are used to mix the two selected channels into a single mixed output stream (steps 404,405,406). For two channels of video, only one transition mix is required (step 406.) For three channels, two channels are mixed into one, then this composite is mixed with the third to produce one final output. It follows that mixing of three channels requires two transition mixes, mixing four channels require three transition mixes, and so on. Once the channels of video selected for concurrent processing have been mixed into a single composite stream, titles can be applied and other editing functions may be carried out. In this regard titles and similar annotations or overlays can be considered simply another video channel and processed as regular video sources (steps 404-406). However, the addition titles and the like is depicted in FIG. 9 (see, e.g., steps 408-409) as a sequence of separate steps as such information is generally not stored in a compressed format within disk storage 240 and is thus not initially decompressed (step 500) along with other compressed digital media content. Just as multiple frames of video image content may be mixed as described above to produce a composite video frame, a number of titles can be mixed with such a composite video frame to produce a single uncompressed composite video output frame 420.

Once such an uncompressed composite video output frame 420 has been computed, the uncompressed composite video output frame 420 may be visually rendered via display 206 (step not explicitly shown). However, additional processing is performed upon the uncompressed composite video output frame 420 by the symmetric CODEC to the extent it is desired to transmit the information within the frame 420 across the band-limited channel 120. Specifically, the uncompressed composite video output 420 is forwarded to a compression engine of the symmetric CODEC (step 600). The frame 420 is received by the compression engine (step 601) undergoes an initial horizontal and vertical wavelet transform (step 602) as described above with reference to FIG. 6. As was described above, the result of this initial transform (step 602) is a first sub-band image information set of one quarter size relative to the frame 420 corresponding to a low-pass sub-band, and three additional sub-band image information sets (each also of one quarter size of the frame 420) corresponding to high-pass sub-bands. The sub-band image information sets corresponding to the three high-pass sub-bands are quantized, run length and entropy encoded (step 603).

In the exemplary embodiment the inventive compression process operates upon groups of two frames (i.e., a two frame GOP structure), and hence processes each of the frames within a given group somewhat differently. Accordingly, it is determined whether an “even” or “odd” frame is currently being processed (step 604). For odd frames only the sub-band image information sets corresponding to the three high-pass bands are transmitted (step 606) to the next processing stage. The low-pass sub-band image information set is buffered (step 605) until the next frame to complete the processing. When an even frame is received, the two low-pass sub-band image information sets of quarter size are summed and differenced using a HAAR wavelet (step 607). The high-pass sub-band image information sets can then be processed in one of two ways. If little differences exist between the two frames of the current 2-frame GOP (step 608), encoding the one of the high-pass sub-band image information sets representative of temporal difference between the frames of the GOP (i.e., the “high-pass temporal sub-band”) (step 609) enables relatively fast computation and high compression. If significant motion is represented by the two frames of the current GOP (step 608), the high-pass temporal sub-band may undergo further compression (step 610). The “motion check” operation (step 608) can be invoked either dynamically based upon the characteristics of the image data being compressed or fixed as a user preference. The low-pass sub-band image information set is representative of the average of the two frames of the current GOP (see, e.g., FIG. 8B), and may also be subjected to further wavelet compression (steps 611, 612, 613) as necessary in view of target data rates. Following any such further compression, the final remaining low-pass sub-band image information set is then encoded (step 614) and output to a buffer or the like in preparation for transmission (step 606.) Referring to FIG. 9, all of the encoded sub-band image information sets are output by the symmetric CODEC and transmitted as compressed data across the band-limited channel 120 (step 610.) The compressed data maybe wrapped in other formats (such as AVI or QuickTime) and/or packetized as needed for transmission via the channel 120. Once the compressed data corresponding to the current frame is transmitted (or buffered for subsequent transmission), the symmetric CODEC determines whether playback is to continue with the next timecode (step 401). It is then determined whether any user prompts have been entered to discontinue playback (step 410) and whether playback has reached the end of the selected sequence (step 412.)

FIGS. 10A and 10B illustratively represent exemplary data formats for video sequences edited in accordance with the present invention. Turning to FIG. 10A, a sequence of GOPs from a “video B” source is shown to be inserted via a pair of “cut” operations between a sequence of GOPs from a “video A” source and a “video C” source. The data format of FIG. 10A, in which edits are effected on GOP boundaries, is believed to be advantageous in that real-time playback is simplified as it is unnecessary to decode only a portion of a particular GOP. Moreover, this format obviates the need to simultaneously execute two decoding operations in connection with a given cut operation. In embodiments where 2-frame GOPs are employed, the short GOP length substantially eliminates the need for editing on sub-GOP boundaries for many applications.

Turning now to FIG. 10B, there is shown an exemplary data format for an edited sequence containing a number of transitions. In the embodiment of FIG. 10B each transition is effected through two simultaneous decoding operations; namely, and mixing operation and an encoding operation. The introduction of single-stream special effects are effected using a single decoding operation implemented using a mix and an encode. It is observed that all of the illustrated editing operations (other than cuts) are effected at least in part using an encoding operation, which may generally be executed quite rapidly by the inventive symmetric CODEC relative to existing encoding techniques. Due to the symmetric and efficient nature of the inventive CODEC, it has been found that the entire editing operation represented by FIG. 10B may be performed in real-time using less processing resources than are required by existing video coding techniques.

Decoding Operation of Video Editor Incorporating Symmetric CODEC

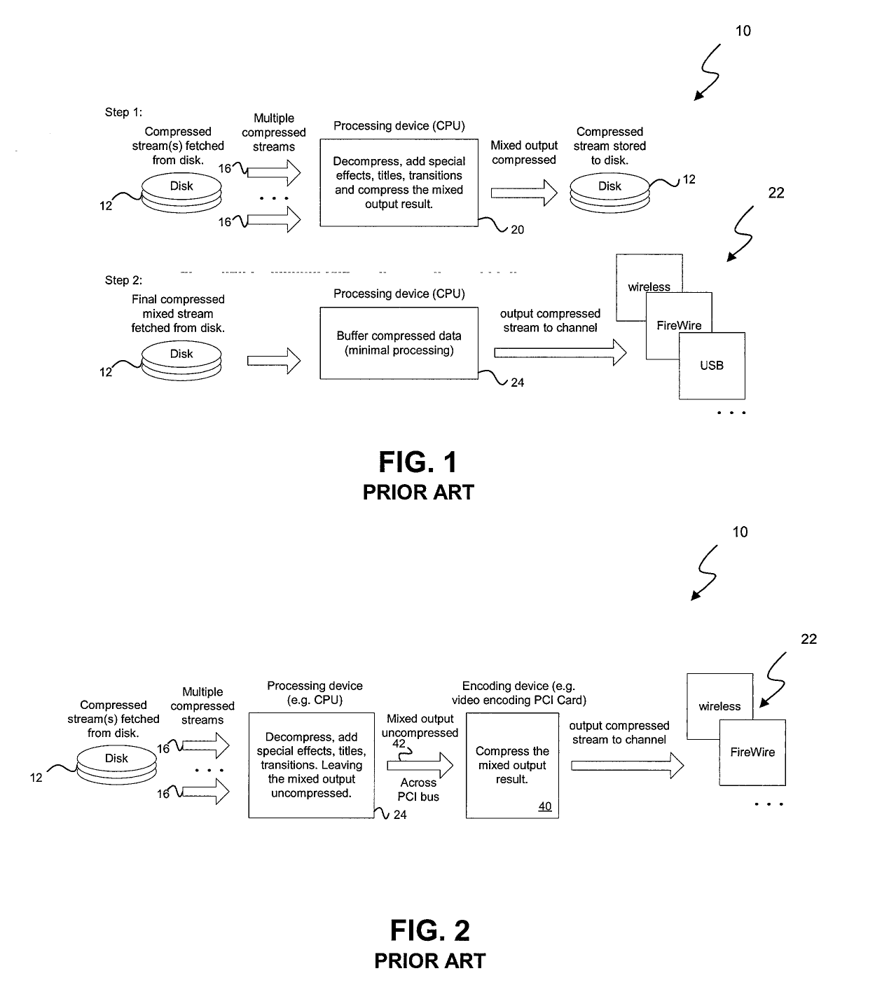

Turning now to FIG. 11, a block diagram is provided of a computer system 700 configured in accordance with an exemplary embodiment of the invention to decode video signals encoded by the encoding system 100. The computer system 700 may be implemented as a conventional personal computer system similar to the encoding system 100 of FIG. 1. In the exemplary embodiment the computer system 700 includes a processor 712, which may be realized using a Pentium-class microprocessor or similar microprocessor device. The computer system further includes memory 720, within which is included an operating system 760, video decoding program 762, and working RAM 764. The video decoding program includes a sequence of program instructions executed by the processor 712 in the manner described below.

In operation, encoded video signals are either retrieved from disk storage 704 or received by receiver 708 via band-limited channel 120. Processor 712 accesses the retrieved or received encoded signals via system bus 716 and decodes the encoded video signals in real-time for storage or display. Decoding of the encoded video signals entails reversing the compression operations implemented by encoding system 100. The resultant decoded signals may be stored within memory 720 by the processor 712 and subsequently provided to display 724 via system bus 716, or may be directly transmitted to display 724 via system bus 716. The display 724 may include a display processor (not shown) for processing the decoded video signals prior to rendering by way of a monitor (not shown) of the display. Such processing may include, for example, digital-to-analog conversion of the decoded video, upsampling, scaling and color conversion. Of course, certain of these processing steps may be implemented by the processor 712 rather than by a display processor of the display 724.

In the exemplary embodiment the encoding system 100 and decoding system 700 are realized as two distinct computer systems operatively coupled by band-limited channel 120. However, a single computer system including the components of systems 100 and 700 may also be used to encode and decode video signals in real-time in accordance with the present invention. In addition, the decoding system of the present invention may comprise a single integrated circuit communicatively linked to the encoding system through a band-limited channel. Such an integrated circuit could be embedded in, for example, a video appliance or the like.

The processor 712 effects decoding of the encoded video signals received over the band-limited channel 120 by reversing each of the steps performed during the above-described encoding process. In particular, each received sub-band is entropy and run-length decoded in order to reconstruct the -uncompressed sub-bands of an original image frame. Once all the sub-bands of the original image frame are decompressed at a wavelet level, the inverse wavelet transforms can be applied. These inverse wavelet transforms are applied in the reverse order of their respective application during the encoding process. With regard to encoding transforms based upon the “2,2” and other HAAR wavelets (such as the temporal difference sub-band and potentially interlaced video field difference sub-bands), the appropriate HAAR inverse transforms are executed during the decoding process. After decoding is carried out with respect to each sub-band encoding level, a higher-resolution version of the original image frame is reconstructed. Once the final (or “top”) level of the original frame is fully decoded, the resultant completely uncompressed video frame may be displayed by the system 700.

It is observed that the present invention may utilized in connection with real-time encoding and decoding of video which has been “interlaced” in accordance with standardized formats (e.g., PAL and NTSC). In such cases, it has been found that use of the 2,2 HAAR wavelet may offer superior performance relative to 2,6 HAAR or other transforms, which are not believed to be as well-suited to compressing temporal differences evidencing greater movement or scene change. In accordance with the invention, temporal differences between fields of interlaced video may be processed in substantially the same manner as temporal differences between frames. One difference may exist with respect to step 602, in which the vertical transform may be effected using a 2,2 HAAR (rather than a 2,6 HAAR) in order to compensate for the temporal nature of the fields. The applicable horizontal transform would generally still be performed using a 2,6 HAAR transform. That, is a shorter transform than is used in connection with other video sources may be employed in connection with the first vertical wavelet compression of interlaced video. Of course, if video from progressive sources (e.g., film or HDTV) is subsequently received, a switch to a longer transform could be very easily performed.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

What is claimed is:

1. A method for generating a compressed video output signal using a computing device, said method comprising:
decoding a previously compressed first digital video bit stream to obtain a first decoded digital video signal;
mixing said first decoded digital video signal with a second digital video signal in order to produce a mixed video signal; and
recompressing said mixed video signal so as to form said compressed video output signal wherein said mixing and recompressing are performed by said computing device in substantially in real-time.

2. The method of claim 1 further including decoding a previously compressed second digital video bit stream to obtain said second digital video signal.

3. The method of claim 1 further including delivering said compressed video output signal over a band-limited channel to an external device.

4. The method of claim 1 wherein said mixing includes editing said first decoded digital video signal using said computing device.

5. The method of claim 1 wherein said recompressing is effected using a symmetric wavelet codec implemented by said computing device.

6. The method of claim 5 wherein said wavelet codec is configured to utilize temporal compression.

7. The method of claim 6 wherein said temporal compression is characterized by a short GOP, thereby enabling fast random access frame retrieval.

8. A computer-implemented system for generating a compressed media output signal, said system comprising:
a memory in which is stored a media mixing program; and
a processor configured to execute said media mixing program and thereby:
decode a previously compressed first media signal to obtain a first decoded media signal,
mix said first decoded media signal with a second media signal in order to produce a mixed media signal, and
recompress said mixed video signal so as to form said compressed media output signal wherein said mixing and recompressing are performed by said processor in substantially in real-time.

9. The computer-implemented system of claim 8 wherein said first decoded media signal comprises a first decoded video signal and said second media signal is obtained by decoding a previously compressed media signal.

10. The computer-implemented system of claim 8 wherein said first decoded media signal comprises a first decoded digital video signal and said second media signal comprises a digital audio signal.

11. The computer-implemented system of claim 8 wherein said media mixing program implements a symmetric wavelet coding routine.

12. A method for generating a compressed media output signal using a computing device, said method comprising:
decoding a previously compressed first media signal to obtain a first decoded media signal;
mixing said first decoded media signal with a second media signal in order to produce a mixed media signal; and
recompressing said mixed media signal so as to form said compressed media output signal wherein said mixing and recompressing are performed by said computing device in substantially in real-time.

13. The method of claim 12 wherein said first decoded media signal comprises a first decoded video signal and said second media signal is obtained by decoding a previously compressed media signal.

14. The method of claim 12 wherein said first decoded media signal comprises a first decoded digital video signal and said second media signal comprises a digital audio signal.

15. The method of claim 12 wherein said recompressing includes implementing a symmetric wavelet coding routine.

16. The method of claim 12 further including transmitting said compressed media output signal over a band-limited channel and subsequently decompressing said compressed media output signal in substantially real-time.

17. A computer-implemented editing system comprising:
a first computing device including:
a memory in which is stored a media mixing program, and
a processor configured to execute said media mixing program and thereby:
decode a previously compressed first media signal to obtain a first decoded media signal,
mix said first decoded media signal with a second media signal in order to produce a mixed media signal, and
recompress said mixed video signal so as to form a compressed media output signal wherein said mixing and recompressing are performed by said processor in substantially in real-time;
a band-limited communication channel in communication with said first computing device; and
a second processor in communication with said band-limited communication channel, said second processor being configured to decompress said compressed media output signal in substantially real-time.

18. The editing system of claim 17 wherein said first computing device and said second computing device are configured to implement a substantially symmetric wavelet codec.

19. A method for generating a compressed video output signal using a computing device, said method comprising:
decoding a previously compressed~first digital video bit stream to obtain a first decoded digital video signal;
mixing said first decoded digital video signal with at least one title or video effect in order to produce a mixed video signal; and
recompressing said mixed video signal so as to form said compressed video output signal wherein said mixing and recompressing are performed by said computing device in substantially in real-time.

20. The method of claim 19 wherein said mixing includes mixing said first decoded digital video signal with a second digital video signal.
